(19) United States
(12) Patent Application Publication
(10) Pub. No.: US 2012/0231174 A1
(43) Pub. Date: Sep. 13, 2012

(54) DEVICE AND METHOD FOR APPLYING PAINTS

(75) Inventor: Stefan FRIESE, Friedrichroda (DE)

(73) Assignee: GM GLOBAL TECHNOLOGY OPERATIONS LLC, Detroit, MI (US)

(21) Appl. No.: 13/411,686

(22) Filed: Mar. 5, 2012

(30) Foreign Application Priority Data
Mar. 7, 2011 (DE) 10 2011 013 307.0

(51) Int. Cl. B05D 1/04; B05D 3/00; B05D 1/36; B05B 15/04; B05B 5/025

(52) U.S. Cl. 427/458; 118/300; 118/621; 427/265; 427/375

(57) ABSTRACT

A device is provided for applying paints that includes, but is not limited to an apparatus for producing a stream of paint particles, a guide element with a surface for limiting the stream of paint particles in space. The guide element is realized in such a way that an area situated adjacent to its surface for limiting the stream of paint particles in space can be kept free of paint particles.

### CROSS-REFERENCE TO RELATED APPLICATION

This application claims priority to German Patent Application No. 10 2011 013 307.0, filed Mar. 7, 2011, which is incorporated herein by reference in its entirety.

### TECHNICAL FIELD

The technical field pertains to a device and a method for applying paints that are suitable for use, for example, in the automotive industry.

### BACKGROUND

Devices of this type typically produced a spray mist of liquid or powdery paint particles that is directed at the surface to be painted. In order to limit the amount of paint wasted during this process, it is in some cases common practice to electrostatically charge the paint particles negatively and to connect the surface to be painted to a different potential such as, for example, the ground potential. Due to this measure, the predominant portion of paint particles is attracted sufficiently strong by the surface to be painted in order to reach this surface and adhere thereon. The latest trends in the automotive industry to produce multicolored vehicles require elaborate steps such as repeated masking and drying during the painting process.

DE 34 35 937 C2 discloses a method for applying paints that is intended to eliminate the need for such a complicated procedure. However, the described method merely makes it possible to produce relatively indistinct transitions between areas of different color.

It is at least one objective to disclose a device for applying paints, by means of which the paint application can be distinctly limited in space. It is at least another objective to disclose a method for applying paints, by means of which multicolored paint applications can be realized as expeditiously as possible. In addition, other objectives, desirable features, and characteristics will become apparent from the subsequent summary and detailed description, and the appended claims, taken in conjunction with the accompanying drawings and this background.

### SUMMARY

According to a first embodiment, a device is disclosed for applying paints with an apparatus for producing a stream of paint particles. The paint particles produced may be liquid or solid and discharged from the apparatus, for example, in the form of a conical spray mist. The device furthermore features a guide element with a surface for limiting the stream of paint particles in space. The guide element is realized in such a way that an area situated adjacent to its surface for limiting the stream of paint particles in space can be kept free of paint particles.

In the context of this description, an area that can be kept free of paint particles is an area, in which the paint particle density can be substantially reduced. Accordingly, the guide element used has such paint-repelling properties that it distinctly limits the original spray mist at least in the area of its surface. In this area, the paint particles are deflected away from the guide element. The stream of paint particles consequently is not limited in space due to the paint particles adhering on or rebounding from the surface of the guide element. In fact, the impact of paint particles on the guide element is prevented due to its paint-repelling properties, namely even if the surface of the guide element is moved into the area of the stream of paint particles.

The resulting spray mist therefore is distinctly limited in certain areas. Consequently, the resulting paint application is also distinctly limited in certain areas. In this case, the shape of the boundary line can be defined, in particular, with the shape of the limiting element and/or by moving the limiting element during the paint application.

The device therefore makes it possible to realize a paint application that is distinctly limited in space without having to carry out a masking step. In this way, two or more different paints can be successively applied without intermediate steps and then jointly dried. Consequently, it is not necessary to intercept and therefore waste part of the spray mist by maskings or shields. Rather, the paint particles are controlled in an active manner.

In one embodiment, the area situated adjacent to the surface for limiting the stream of paint particles in space can be kept free of paint particles by means of a gas current. The gas current may consist, in particular, of a compressed air current. In order to generate the gas current, a compressed air source may be provided and arranged in such a way that the gas current is essentially directed parallel to the surface for limiting the stream of paint particles in space. Additionally or alternatively, a compressed gas source provided for generating the gas current may be arranged in such a way that the gas current is essentially directed away from the surface for limiting the stream of paint particles in space perpendicularly. In both instances, the gas current promotes a transport of paint particles in a predominant direction along or away from the surface of the guide element, but not toward this surface.

In order to apply paint, the guide element can be arranged relative to the apparatus for producing a stream of paint particles and to the surface to be painted in such a way that it controls the paint particles. The guide element can be positioned, in particular, in the vicinity of the apparatus for producing the stream of paint particles with one end and a short distance from the surface to be painted with its other end such that it shields part of the surface to be painted from impacting paint particles. This shielding effect preferably is not or not only achieved due to the adhesion of paint particles on the guide element and therefore an interception of paint particles of the spray mist, but rather at least predominantly with the control effect of the guide element. As already mentioned above, this control effect can be realized with a gas current.

Alternatively or additionally, an electrostatic repulsion between the paint particles and the surface of the guide element can also be utilized for the control effect. To this end, the device may also feature an apparatus for electrostatically charging the surface of the guide element that serves for limiting the stream of paint particles in space. This is particularly advantageous in instances, in which the device features an apparatus for electrostatically charging the paint particles in accordance with conventional modern painting techniques. In this case, the paint particles and the surface of the guide element may be charged, for example, to the negative potential and the surface to be painted may be connected to the ground potential such that repelling forces act between the paint particles and the surface of the guide element while attractive forces act between the paint particles and the surface to be painted.

In one embodiment, the guide element is realized in the form of a plate and a principal surface of the plate forms the surface for limiting the stream of paint particles in space. In one embodiment, the surface for limiting the stream of paint particles in space features a paint-repelling material that consists, for example, of a material with lotus effect or a material containing polytetrafluoroethylene.

Although this does not have a direct control effect on the paint particles, the paint particles are prevented from adhering permanently. In this way, the cleaning effort for the device is reduced and the control of the spray mist is enhanced. The described device can be used in all instances, in which a paint application needs to be distinctly limited in space, particularly for painting motor vehicles such as, for example, multicolored motor vehicles.

According to one embodiment, an industrial robot arrangement for painting motor vehicles features the described device. In this case, it would be conceivable to mount the apparatus for producing the stream of paint particles and the guide element on the same robot arm. Alternatively, it would also be conceivable to mount the apparatus and the guide element on different robot arms or even on different robots such that they can be actuated and positioned independently of one another.

According to one embodiment, a method for applying paints with the following steps producing a stream of paint particles, directing the stream of paint particles at a surface to be painted in a controlled fashion, where the stream of paint particles is limited to a fraction of its cross section prior to impacting on the surface to be painted by deflecting the paint particles from this fraction of the cross section.

In this method, a usually conical spray mist with round or oval cross section therefore is initially produced. This spray mist can be additionally limited or shaped with conventional measures such as control air. However, this still takes place while the spray mist is produced, for example, by means of a bell cup or corresponding nozzles. Subsequently, the spray mist is limited to a fraction of its cross section before impacting on the surface to be painted. This limiting of the spray mist takes place independently of its production such that the production of paint particles and the limiting thereof can be controlled independently of one another.

The deflection of the paint particles can be achieved with a gas current and/or electrostatic control. In this respect, it would be possible to realize an electrostatic repulsion, as well as an attraction, wherein electrostatic repulsion from the guide element makes it possible to distinctly limit the stream of paint particles in a particularly simple fashion. In one embodiment, the deflection is realized with a guide element, the surface of which has a repelling effect on the paint particles.

In one embodiment, the method comprises the application of paint of a first color in at least a first area of the surface to be painted and the application of paint of a second color in a second area of the surface to be painted. The paint application in the second area is distinctly limited relative to the first area, as well as the subsequent joint drying and/or fusing of the paint in the first and the second area.

With this method, the entire paint application can be realized before a single drying or fusing step is carried out. Significant time savings and cost savings can be achieved in this way.

### BRIEF DESCRIPTION OF THE DRAWINGS

The present invention will hereinafter be described in conjunction with the following drawing figures, wherein like numerals denote like elements, and:

FIG. 1 schematically shows a device for applying paints according to an embodiment;

FIG. 2 schematically shows details of the device according to FIG. 1; and

FIG. 3 schematically shows further details of the device according to FIG. 1.

### DETAILED DESCRIPTION

The following detailed description is merely exemplary in nature and is not intended to limit the invention or the application and uses. Furthermore, there is no intention to be bound by any theory presented in the preceding background or summary or the following detailed description.

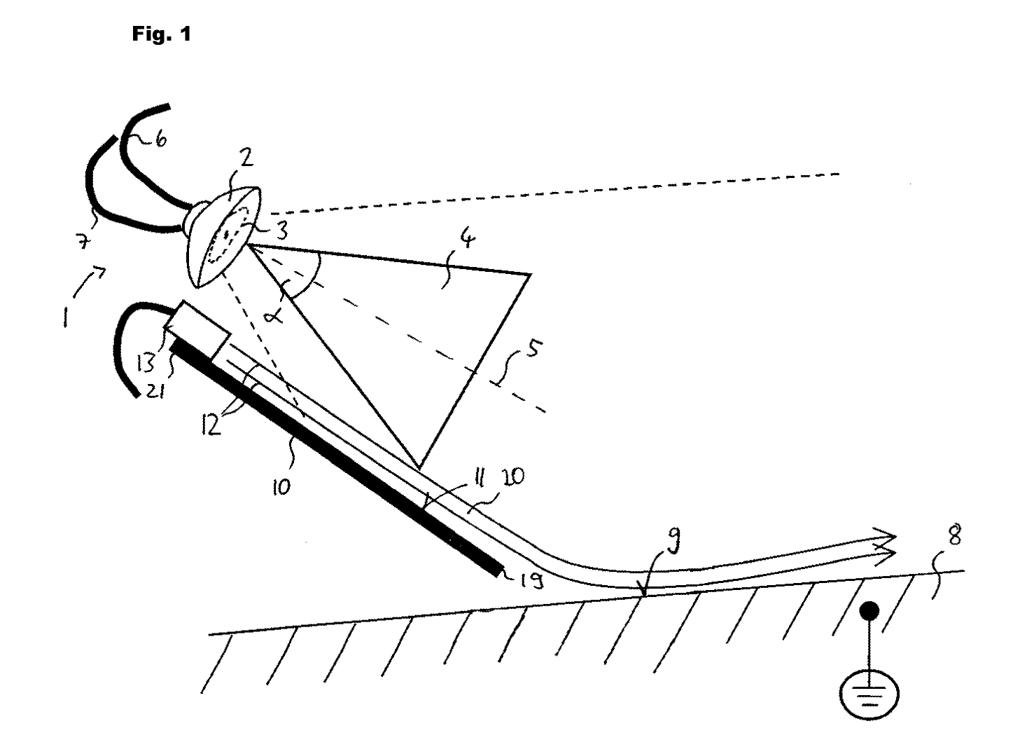

The device 1 for applying paints according to FIG. 1 comprises an atomizer 2 that may be realized, for example, in the form of a rotary atomizer with a bell cup. The atomizer 2 comprises a compressed air supply 6 and a paint supply 7 and produces a spray mist in the form of a cone 4 of paint particles that are electrostatically charged either directly or indirectly on an annularly revolving spraying edge 3. The paint cone 4 has an axis of symmetry 5 and an aperture angle α.

The negatively charged paint particles of the paint cone 4 stream in the direction of the car body element 8 containing the area 9 to be painted. The car body element 8 is connected to the ground potential in order to control the particle stream in the paint cone 4 and to maintain the material loss caused by a unidirectional spray mist at a minimum. In order to distinctly limit the paint layer to be applied at least in certain areas, the device 1 for applying paints features a guide element in the form of a guide plate 10. The guide plate 10 is arranged in the vicinity of the atomizer 2 with its upper end 21 and in the vicinity of the area 9 to be painted with its lower end 19.

The guide plate 10 has a surface 11 for limiting the stream of paint particles in space, i.e., the surface 11 is realized in such a way that it limits the paint cone 4 and therefore also the paint applied onto the area 9 to be painted in space on at least one side. For this purpose, the guide plate 10 features a compressed air source 13 that is mounted in the area of its upper end 21 such that the exiting compressed air flows over the surface 11 of the guide plate 10 in the direction of the arrows 12 and causes a deflection of the paint particle stream parallel to the surface 11 of the guide plate 10. Consequently, paint particles in the vicinity of the surface 11 are entrained by the compressed air and transported to the area 9 to be painted before they can reach the surface 11 of the guide plate 10.

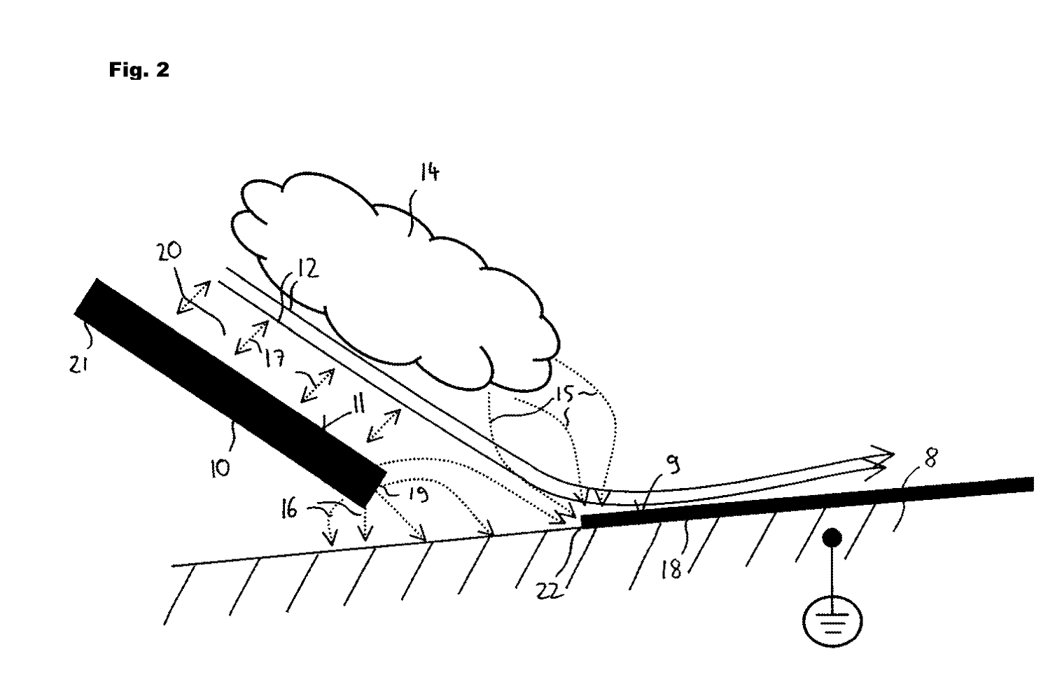

Consequently, the area 20 on the surface 11 of the guide plate 10 is largely kept free of paint particles. Another measure for keeping the area 20 free of paint particles is illustrated in FIG. 2. FIG. 2 shows the device according to FIG. 1, particularly a detail of the spray mist 14 in the form of a paint cone 4. In the embodiment shown, the surface 11 of the guide plate 10 is on the same electric potential as the particles of the spray mist 14, i.e., it is also negatively charged.

This results in repelling electrostatic forces between the surface 11 and the particles of the spray mist 14 as indicated with arrows 17, as well as in attracting electrostatic forces between the particles of the spray mist 14 and the area 9 to be painted as indicated with arrows 15 and in attracting electrostatic forces between the lower end 19 of the guide plate 10 and the area 9 to be painted as indicated with arrows 16. The resulting field distribution promotes the transport of paint particles to the area 9 to be painted such that a distinct limitation 22 is achieved. In addition, the surface 11 of the plate may feature a paint-repelling material. This measure not only promotes the limiting of the paint cone 4 in space, but also has the additional effect of preventing paint particles that reach the surface 11 despite all other measures from adhering thereto. The guide plate 10 therefore remains clean.

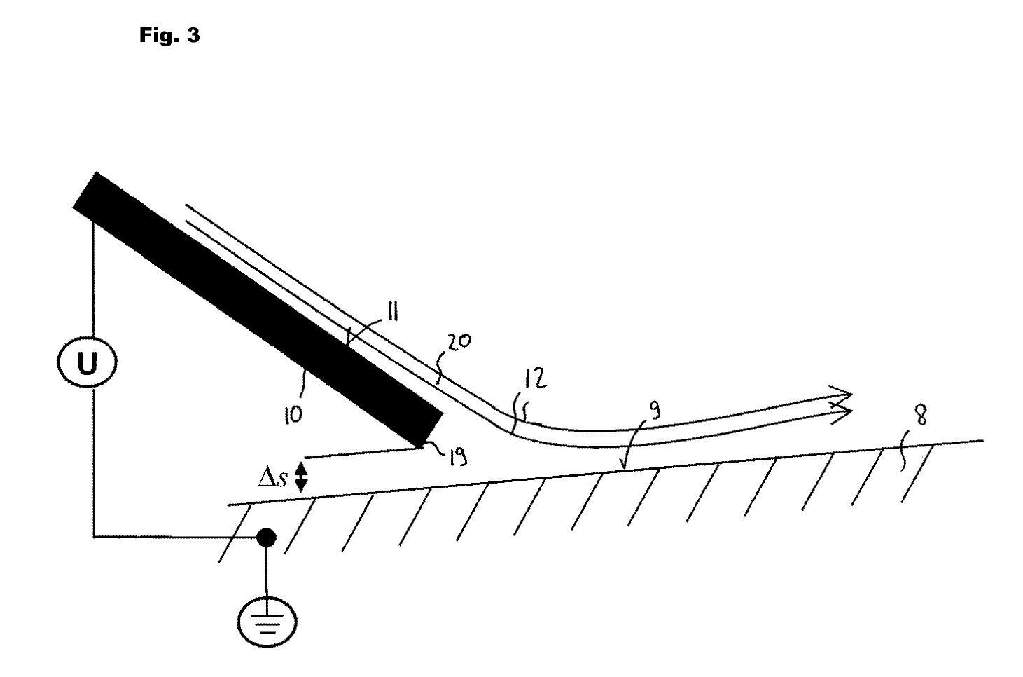

FIG. 3 schematically shows the lower area 19 of the guide plate 10. Due to the different potentials of the guide plate 10 and the car body element 8, the lower area 19 of the guide plate 10 is spaced apart from the car body element 8 by distance deltas (Δs) that are dimensioned such that flashovers are prevented. The quality of the paint application and, in particular, the distinctiveness of the limitation 22 may, among other things, depend on the angle, by which the guide plate 10 is inclined relative to the car body element 8 to be painted, the distance Δs, the volumetric flow rate of the paint particles and, in particular, the compressed air and the intensity and the progression of the electric field between the guide plate 10 and the car body element 8. The device 1 makes it possible to initially apply a paint layer 18 with a distinct limitation 22 in an area 9 to be painted and to subsequently apply another paint layer of a different color in an area situated adjacent to the distinct limitation 22 without any intermediate steps such as masking or drying.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for applying paints, comprising:
an apparatus that is configured to produce a stream of paint particles; and
a guide element with a surface that is configured to limit the stream of paint particles in space,
wherein the guide element is configured such that an area is situated adjacent to a surface that is configured to limit the stream of paint particles in space is kept substantially free of paint particles.

2. The device according to claim 1, wherein the area situated adjacent to the surface that is configured to limit the stream of paint particles in space is kept substantially free of the paint particles with a gas current.

3. The device according to claim 2, further comprising a compressed gas source that is configured to produce the gas current and arranged such that the gas current is essentially directed parallel to the surface.

4. The device according to claim 2, further comprising a compressed gas source that is configured to produce the gas current and arranged such that the gas current is essentially directed away from the surface.

5. The device according to claim 1, further comprising a second apparatus configured to electrostatically charge the paint particles.

6. The device according to claim 1, further comprising a second apparatus that is configured to electrostatically charge the surface of the guide element.

7. The device according to claim 1, wherein the guide element is a plate and a principal surface of the plate is configured to form the surface.

8. The device according to claim 1, wherein the surface comprises a paint-repelling material.

9. The device according to claim 8, wherein the paint-repelling material comprise a material with a lotus effect.

10. The device according to claim 8, wherein the paint-repelling material comprises polytetrafluoroethylene.

11. A method for applying paints, comprising:
producing a stream of paint particles;
directing the stream of paint particles at a surface to be painted in a controlled fashion,
wherein the stream of paint particles is limited to a fraction of a cross section prior to impacting a surface to be painted by deflecting paint particles from the fraction of the cross section.

12. The method according to claim 11, wherein the deflecting of the paint particles is a gas current.

13. The method according to claim 11, wherein the deflecting of the paint particles is an electrostatic charge.

14. The method according to claim 11, wherein the deflecting is a guide element having a surface with a repelling effect on the paint particles.

15. The method according to claim 11, further comprising:
applying of a first paint of a first color in at least a first area of the surface to be painted;
applying of a second paint of a second color in a second area of the surface to be painted, wherein the applying of the second in the second area has a distinct limitation relative to the first area; and
joint fusing of the first paint and the second in the first area and the second area.

16. The method according to claim 12, wherein the fusing comprises drying.
